(19) United States
(12) Patent Application Publication
(10) Pub. No.: US 2008/0003371 A1
(43) Pub. Date: Jan. 3, 2008

(54) Manufacturing method and product of fragrant plastic tile

(76) Inventor: Chun-Shien Ko, (US)

Correspondence Address: TROXELL LAW OFFICE PLLC, SUITE 1404, 5205 LEESBURG PIKE, FALLS CHURCH, VA, 22041, US

(21) Appl. No.: 11/454,001

(22) Filed: Jun. 16, 2006

(51) Int. Cl. B05D 7/00; C08F 2/46; B05D 1/28; B05D 1/36

(52) U.S. Cl. 427/402; 427/532; 427/487; 427/428.01

(57) ABSTRACT

A manufacturing method of a fragrant plastic tile includes various steps of coating a special UV sensitive resin containing perfume on a plastic tile to disperse fragrant smell, and of photo-curing at least one layer of the fragrant UV sensitive resin on a semi-finished plastic tile by UV lights. Therefore, a product of the fragrant plastic tile has a protective layer of the fragrant UV sensitive resin hardened on the plastic tile, and the layer is to be slowly rubbed off, able to disperse fragrant smell in the air, advancing an extra added value. The product of the fragrant plastic tile includes a plastic tile and two layers of fragrant UV sensitive resin coated on the surface of the plastic tile.

### BACKGROUND OF THE INVENTION

1. Field of the Invention

This invention relates to a manufacturing method and product of a fragrant plastic tile, which has an outer protective layer of UV sensitive resin containing a fragrant perfume so that it is able to disperse fragrant smell into the air so as to advance an extra added value.

2. Description of the Prior Art

Commonly, a conventional plastic tile disperses an awful plastic smell, especially in a confined space, apt to embarrass or annoy people and harmful to health as well.

Moreover, the surface treatment of the conventional plastic tile involves plural steps so as to obtain a smooth and glossy surface that is unfortunately easy to be abraded away, forming an uneven surface and lessening its service life.

Therefore, the conventional plastic tile has the following disadvantages as can be seen from the foresaid description.

1. An awful plastic smell dispersed from a conventional plastic tile is apt to discomfort or annoy people and harmful to health as well.

2. The surface of the conventional plastic tile is not protected by any hard layer, permitting it to be rubbed off easily to get its service life shortened.

### SUMMARY OF THE INVENTION

The objective of this invention is to offer a manufacturing method and product of a fragrant plastic tile that is coated with an UV sensitive resin mixed with a perfume, able to be slowly rubbed off to release fragrant smell into the air, advancing an extra added value.

The main processes of the invention are to apply two layers of UV sensitive resin photo cured by UV lighting on the surface of a semi-finished plastic tile. Therefore, the product of the invention has a protective layer of UV sensitive resin containing perfume, able to prohibit growth of germs or bacteria and release fragrant smell into the air while the protective layer is slowly rubbed off, advancing an extra added value.

### BRIEF DESCRIPTION OF DRAWINGS

This invention is better understood by referring to the accompanying drawings, wherein:

FIG. 1 is a flow chart of a manufacturing method of a fragrant plastic tile in the present invention;

FIG. 2 is a flow view of the manufacturing method of a fragrant plastic tile in the present invention;

FIG. 3 is a partial magnified view of “A” and “B” marked with dotted lines in FIG. 2;

FIG. 4 is a cross-sectional view of a preferred embodiment of a product of a fragrant plastic tile in the present invention; and

FIG. 5 is a perspective view of the preferred embodiment of a product of a fragrant plastic tile in the present invention.

### DETAILED DESCRIPTION OF THE PREFERRED EMBODIMENT

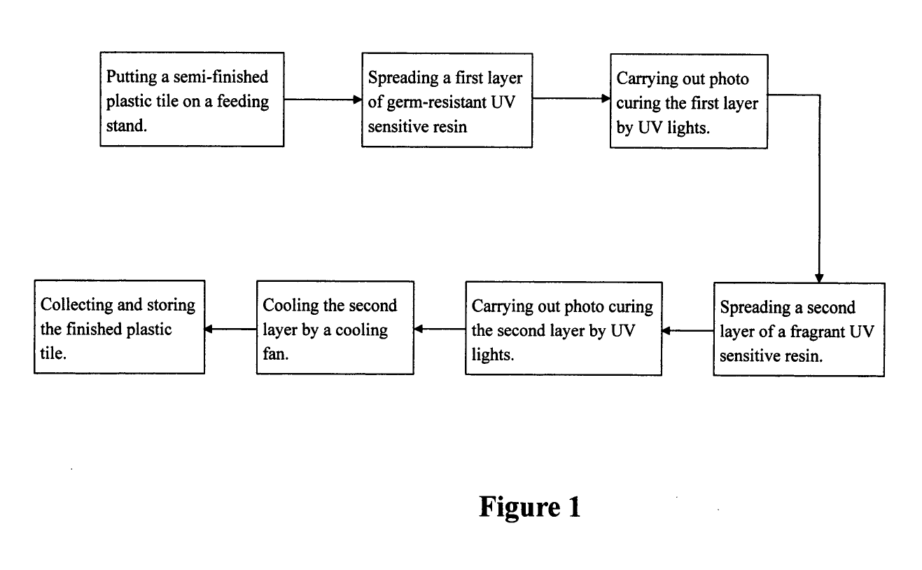

As shown in FIGS. 1˜5, a preferred embodiment of a manufacturing method of a fragrant plastic tile in the present invention includes following processes orderly.

A first step of preparing a semi-finished plastic tile 10 and putting it on a feeding stand.

A second step of spreading a first layer of a fragrant UV sensitive resin 11 containing a perfume by roller coating 100 on the semi-finished plastic tile 10.

A third step of carrying out photo curing by first UV lighting 200 to keep the first layer of the fragrant UV sensitive resin 11 hardened.

A fourth step of spreading a second layer of the fragrant UV sensitive resin 12 by roller coating 300 on the semi-finished plastic tile 10 with the first hardened layer of the fragrant UV sensitive resin 11.

A fifth step of carrying out photo curing by second UV lighting 400 to keep the second layer of the fragrant UV sensitive resin 12 hardened.

A sixth step of cooling the plastic tile with the two layers of the fragrant UV sensitive resin 11 and 12 by a cooling fan 500.

A seventy step of collecting the finished fragrant plastic tile 1 with the two layers of the fragrant UV sensitive resin 11 and 12 and storing them on a collecting stand 600.

Next, each of the processes mentioned above is described in detail below.

First, put the semi-finished plastic tile 10 on the feeding stand. Next, spread evenly a first layer of the fragrant UV sensitive resin 11 on the semi-finished plastic tiles 10 by the first roller coating 100. Then, the first layer of the fragrant UV sensitive resin 11 on the semi-finished plastic tile 10 is photo-cured by at least one set of UV lights 200, forming the first layer of the fragrant UV sensitive resin 11 coated with a great adhesion on the semi-finished plastic tiles 10, uneasy to be peeled off. Then a second layer of the fragrant UV sensitive resin 12 is successively coated on the first hardened layer of the fragrant UV sensitive resin 11 by the second roller coating 300 and then, photo-cured by at least a second set of UV lights 400, forming a second layer of the fragrant UV sensitive resin 12 coated with a great adhesion on the first hardened layer of the fragrant UV sensitive resin 11. Then a cooling fan 500 is used to cool the second hardened layer of the fragrant UV sensitive resin 12 down so that the finished fragrant plastic tile 1 can be quickly collected and stored on the collecting stand 600.

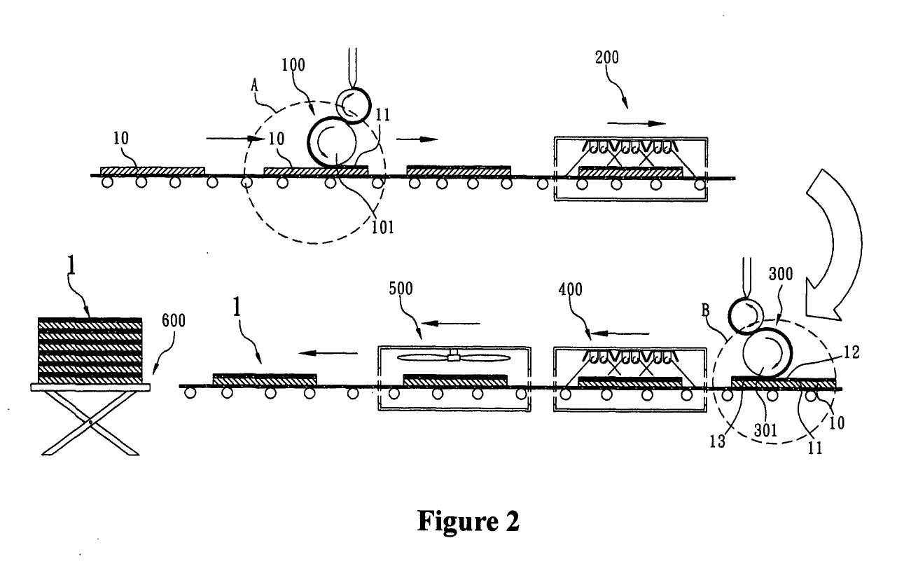

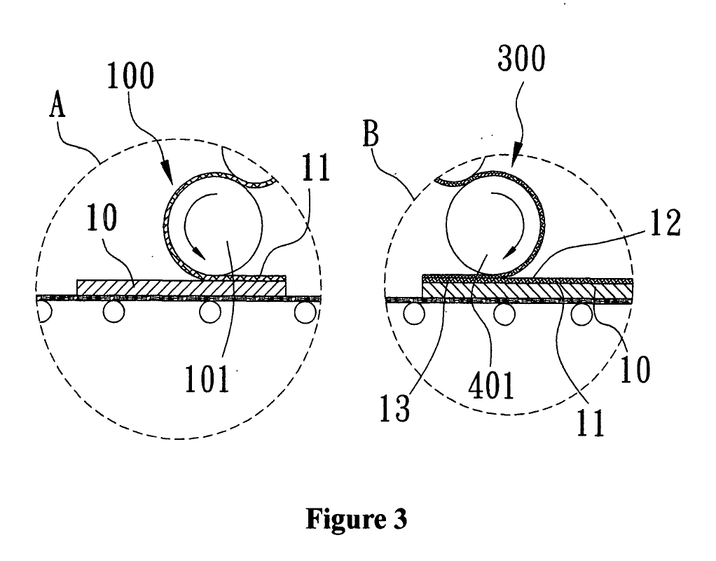

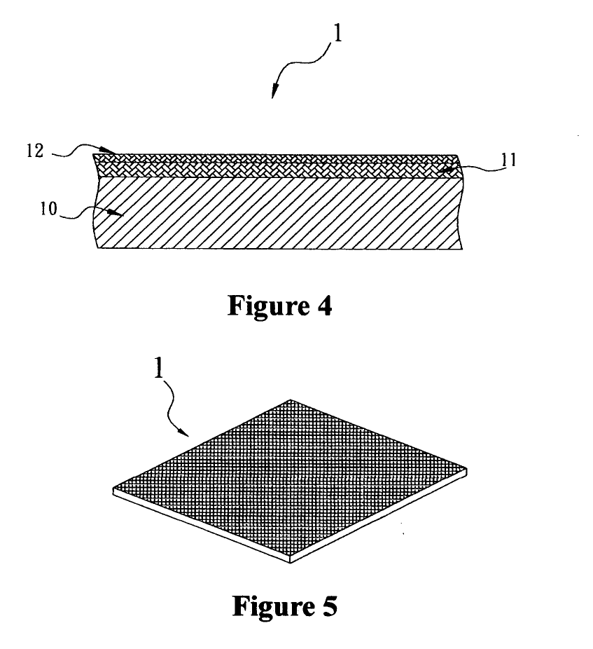

As shown in FIG. 3, in a partial magnified view of “A” and “B” in FIG. 2, the first roller coating situation “A” illustrates how the first layer of the fragrant UV sensitive resin 11 is spread by the first roller coating 100 and the second roller coating situation “B” illustrates how the second layer of the fragrant UV sensitive resin 12 is spread by the second roller coating 300.

The invention has the following advantages as can be seen from the foresaid description.

1. The fragrant UV sensitive resin serves as a protective layer on the plastic tile, able to lengthen the service life of the plastic tile.

2. The protective layer formed by the fragrant UV sensitive resin is to be very slowly and gradually rubbed off, able to disperse fragrant smell in the air for a long period of time and cover the awful plastic smell to let people feel refreshed, advancing an added value for the plastic tile.

While the preferred embodiment of the invention has been described above, it will be recognized and understood that various modifications may be made therein and the appended claims are intended to cover all such modifications that may fall within the spirit and scope of the invention.

What is claimed is:

1. A manufacturing method of a fragrant plastic tile comprising:
a first step of preparing a semi-finished plastic tile and placing said tile on a feeding stand;
a second step of spreading a first even layer of a fragrant UV sensitive resin containing a perfume on said semi-finished plastic tile by a coating device;
a third step of carrying out photo-curing of said first layer of said UV sensitive resin by at least one set of UV lights;
a fourth step of spreading a second layer of said fragrant UV sensitive resin on said first hardened layer of said fragrant UV sensitive resin by a coating device;
a fifth step of carrying out photo-curing of said second layer of said UV sensitive resin by at least one set of UV lights;
a sixth step of cooling down said second hardened layer of said fragrant UV sensitive resin by a cooling device; and
a seventh step of collecting and storing said finished fragrant plastic tile on a collecting stand.

2. A manufacturing method of fragrant plastic tile as claimed in claim 1, wherein said coating device is a roller coating device.

3. A manufacturing method of fragrant plastic tile as claimed in claim 1, wherein said coating device is a device of spreading coating on said semi-finished plastic tile.

4. A manufacturing method of fragrant plastic tile as claimed in claim 1, wherein said two layers of said UV sensitive resin are respectively mixed with perfume that is able to prohibit a growth of germs and bacteria and dispersing a fragrant smell.

5. A manufacturing method of fragrant plastic tile as claimed in claim 1, wherein said cooling device is a cooling fan.

6. A manufacturing method of fragrant plastic tile as claimed in claim 1, wherein said cooling process is dependent on a natural wind.

7. A fragrant plastic tile characteristically comprising a protective layer on its surface that is composed of a resin and perfume.
